(19) United States
(12) Patent Application Publication
(10) Pub. No.: US 2022/0098071 A1
(43) Pub. Date: Mar. 31, 2022

(54) METHOD FOR CARBON SOURCE REPLACEMENT FOR DENITRIFICATION PROCESS IN WASTEWATER TREATMENT

(71) Applicant: BASF FRANCE SAS, 92300 Levallois-Perret (FR)

(72) Inventors: Feng WANG, Shanghai (CN); Deyou TANG, Shanghai (CN); Stephanie FOUCHER, Shanghai (CN); Ki-Hwan SON, Ulsan (KR); Jung-UK PARK, Ulsan (KR); Heajin HWANG, Ulsan (KR); Virginie THIEBLEMONT, Shanghai (CN)

(21) Appl. No.: 17/427,392

(22) PCT Filed: Jan. 30, 2020
(86) PCT No.: PCT/EP2020/052325

§ 371 Date: Jul. 30, 2021

(30) Foreign Application Priority Data
Feb. 1, 2019 (CN) PCT/CN2019/074343

(51) Int. Cl. C02F 3/30

(52) U.S. Cl. CPC C02F 3/305; C02F 2103/36

(57) ABSTRACT

The present invention relates to a method for the carbon source replacement for denitrification process in wastewater treatment.

The present invention relates to a method for the carbon source replacement for denitrification process in wastewater treatment.

### PRIOR ART

Nowadays, rising nitrate pollution has developed into an important environmental issue rapidly both in industrialized countries and developing countries. From China's environmental bulletin in 2009, during 641 sampling wells in 8 districts including Beijing, Liaoning, Jilin, Shanghai, Jiangsu, Hainan, Ningxia, and Guangdong, 73.8% of the wells contained nitrate with a concentration over 20 mgNO₃—N·L⁻¹, which was more than 2 times as the drinking water standard (10 mgNO₃—N·L⁻¹) set by United States Environmental Protection Agency (USEPA). Also the wastewater total nitrogen (TN) discharge limit in China is more and more strict, for example, sewage discharge into urban sewer water quality standards (2015) requires outlet TN less than 70 mg/L (A and B), and less than 45 mg/L (C); Pollutant discharge standards for urban sewage treatment plants (2016) requires for total nitrogen (TN) less than 5 mg/L (first grade A).

There're different methods to remove nitrate from water. Conventional physical-chemical methods can remove nitrate by ion exchange, reverse osmosis and electro-dialysis, but all of these processes are expensive and the concentrated waste brines require further treatment or disposal. The use of biological denitrification to convert nitrates to harmless nitrogen gas could offer an alternative treatment process for the remediation of nitrate contaminated effluent by effect of the high specificity of denitrifying bacteria, which is low cost and high denitrification efficiency.

Biological denitrification involves the biological oxidation of many organic substrates in wastewater treatment using nitrate as the electron acceptor instead of oxygen. Generally, denitrification process takes place in bacteria present in the activated sludge through a series of four steps, from nitrate to nitrogen gas by NaR (nitrate reductase), Nir (nitrite reductase), NOR (nitric oxide reductase), N₂OR (nitrous oxide reductase). The denitrification model with four steps was shown as equation (1).

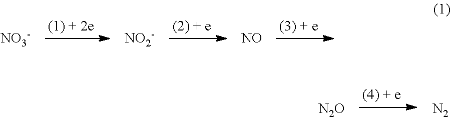

In biological nitrogen removal processes, the electron donor is typically one of three sources: (1) the soluble chemical oxygen demand (COD) in the inlet wastewater, (2) the soluble COD produced during endogenous decay, and (3) an exogenous source such as methanol or acetate. In many cases, external carbons source is needed. When the price of the external carbon increased or supply quantity decrease due to some special reason, there is a need to find substitute to replace original carbon source. Since the activated sludge/bacteria already adapted to the existing carbon source for a long time, it is a big challenging to switch carbon source smoothly without any disturbing performance.

CN-A 107162175 describes a method for degrading penicillin by using glucose as co-substrate. This document, however, does not teach or suggest denitrifying process for nitrate wastewater and, in particular, does not mention how to switch carbon source in denitrifying process.

It is still an unmet need to provide effective methods for removing nitrate from wastewater. Such method may include replacing a carbon source in a wastewater denitrifying process. This is challenging as the viability and activity of microorganisms may suffer from replacing one carbon source by another.

Surprisingly, it was found that a method for replacing a carbon source (by another carbon source) in a wastewater denitrifying process can be effectively performed when the content of the second carbon source is increased stepwise, preferably based on the total chemical oxygen demand (COD). The method as claimed provides a particularly effective method for replacing a carbon source in a wastewater denitrifying process. Preferred ratios and times are provided below.

### INVENTION

The present invention relates to a method for replacing a carbon source in a wastewater denitrifying process, wherein the process comprises a step of treating nitrogen-containing, in particular nitrate-containing, wastewater with a first carbon source, the method for replacing the carbon source comprises the steps of:

a) replacing the first carbon source with a second carbon source which is different from the first carbon source, wherein the second carbon source is increased by an amount percentage of 1-15% by weight, based on the total chemical oxygen demand of the first carbon source and the second carbon source;
b) treating the wastewater with the mixture of the first carbon source and the second carbon source obtained in step a) for 10-20 days; and
c) repeating steps a) and b) until at least until 50% of the first source is replaced; wherein the first carbon source is further replaced with the second carbon source after step c) is completed until the first carbon source is completely replaced by the second carbon source,
wherein the ratio of total chemical oxygen demand of the mixture of the first carbon source and the second carbon source to total nitrogen of inlet wastewater in step b) is from 3.0 to 5.0.

In other words, the present invention relates to a method for denitrification, wherein the process comprises a step of treating wastewater with a first carbon source, the method for replacing the carbon source comprises the steps a)-c) as described herein, wherein the ratio of total chemical oxygen demand of the mixture of the first carbon source and the second carbon source to total nitrogen of inlet wastewater in step b) is from 3.0 to 5.0.

The present invention further pertains to a method for replacing a carbon source in a wastewater denitrifying process, wherein the process comprising a step of treating wastewater with a first carbon source, the method for replacing the carbon source comprises the steps of:

a) replacing the first carbon source with a second carbon source, wherein the second carbon source has an amount percentage of 1-15% by weight, based on the total chemical oxygen demand of the first carbon source and the second carbon source at least until 50% of the first source is replaced;
b) treating the wastewater with the mixture of the first carbon source and the second carbon source obtained in step a) for 10-20 days;
c) repeating steps a) and b) until the first carbon source is completely replaced by the second carbon source;
wherein the ratio of total chemical oxygen demand of the mixture of (the) first carbon source and the second carbon source to total nitrogen of (the) inlet wastewater in step b) is from 3.0 to 5.0.

The process of the present invention permits to treat wastewater with desired characteristics such as meeting the requirement of wastewater treatment, high efficiency, and cost-saving, sustainable qualified treated wastewater outlet.

### BRIEF DESCRIPTION OF DRAWINGS

FIG. 1 is an image of TN removal under different COD/TN ratio.

FIG. 2 is an image of COD residue under different COD/TN ratio

FIG. 3 is an image of impact of COD/TN on denitrification

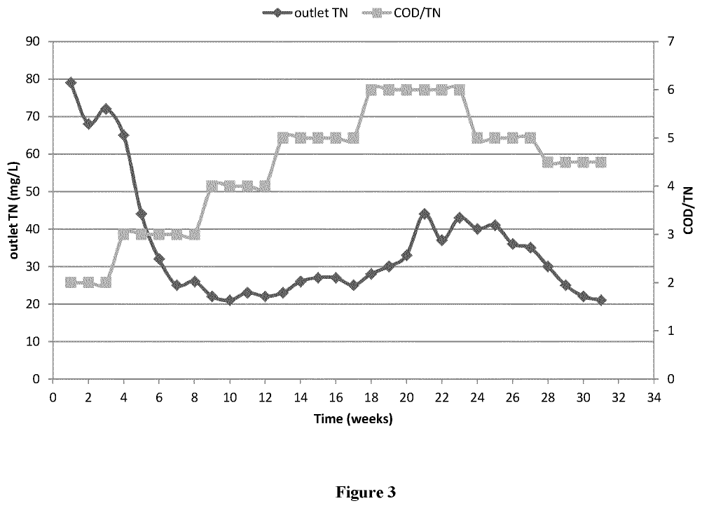

### DEFINITIONS

As used herein, the articles “a”, “an” and “the” are used to refer to one or to more than one (i.e., to at least one) of the grammatical object of the article.

The term “and/or” includes the meanings “and”, “or” and also all the other possible combinations of the elements connected to this term.

As used herein, “weight percent”, “%,”, “percent by weight”, “% by weight,” and variations thereof refer to the concentration of a substance as the weight of that substance divided by the total weight of the composition and multiplied by 100.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a maintaining day range of about 10 days to about 20 days should be interpreted to include not only the explicitly recited limits of about 10 days to about 20 days, but also to include sub-ranges, such as 10 days to 15 days, 15 days to 20 days, and so forth, as well as individual amounts, including fractional amounts, within the specified ranges, such as 10.5 days, 12.5 days, and 18.5 days, for example.

The term “from” should be understood as being inclusive of the limits.

It is specified that, in the continuation of the description, unless otherwise indicated, the values at the limits are included in the ranges of values which are given. It should be noted that in specifying any range of weight ratio or temperature, any particular upper weight ratio or temperature can be associated with any particular lower concentration.

As used herein, the term “chemical oxygen demand” and its abbreviation “COD” may be understood in the broadest sense as commonly understood in the art. Chemical oxygen demand (COD) may be understood as representing one or more energy sources which physiological metabolism consumes oxygen in the wastewater. Thus, chemical oxygen demand (COD) may refer to one or more organic matters, i.e., one or more carbon sources. The conversion factor for chemical oxygen demand (COD) is laid out below. Chemical oxygen demand (COD) may be an indicative measure of the amount of oxygen that is consumed by reactions in the wastewater of interest. It may be understood as the (theoretical) demand of equivalents of oxygen of the wastewater (including organic matters, i.e., one or more carbon sources, and optionally inorganic maters such as nitrate). Chemical oxygen demand (COD) may be quantifyable as mass of oxygen consumed over volume of the wastewater such as, e.g., expressed in milligrams per liter (mg/L). It may be used to quantify and compare the amount of organics in water. This may enable comparison and normalization of amounts of different energy sources, in particular different carbon sources, in a solution.

As used herein, the term “carbon source” may be understood in the broadest sense as any chemical entity that is usable by organism as the source of carbon metabolized for, e.g., maintaining viability and/or building its biomass. In general, a carbon source may be an organic compound or an inorganic compound. As used herein, a carbon source is preferably an organic compound.

The total chemical oxygen demand (COD) of the mixture of the first carbon source and the second carbon source may be understood as the total COD of the sum of the first and the second carbon source. Preferably, the total COD is the sum of all carbon sources present in the wastewater.

The total nitrogen (TN) (of inlet wastewater) may be understood as the entire nitrogen content present in the medium of interest (e.g., in the wastewater). The entire nitrogen content present in the medium of interest is preferably the nitrogen content dissolved or suspended, in particular dissolved, in the medium of interest. The entire nitrogen content may include (or consist of) nitrogen-containing chemical entities selected from the group consisting of inorganic ions (e.g., nitrate, nitride, ammonium, or combinations thereof), organically bound nitrogen (e.g., urea, biological macromolecules, peptides, amino acid, and derivatives and/or combinations thereof), and combinations thereof.

The ratio of the total chemical oxygen demand (COD) of the mixture of the first carbon source and the second carbon source to total nitrogen (TN) of inlet wastewater may also be expressed as COD/TN.

When the medium of interest (e.g., the wastewater) has a certain volume, the total chemical oxygen demand (COD) and/or the total nitrogen (TN) may each be expressed as a concentration (e.g., expressible as milligrams per liter (mg/L)). The ratio COD/TN may be dimensionless.

As used herein, wastewater may be any sewage. Preferably, the wastewater of interest in the context of the present invention contains nitrogen, preferably contains nitrite or nitrate, in particular contains nitrate. The wastewater may contain (sewage) sludge.

Sludge typically contains microorganisms, in particular bacteria. Preferably, such microorganisms, in particular bacteria, facilitate one or more steps of transforming at least parts of the nitrogen content of the wastewater to nitrogen gas. In particular, such microorganisms, in particular bacteria, facilitate one or more steps of transforming nitrate of the wastewater to nitrogen gas. Such microorganisms, in particular bacteria, may also be designated as being denitrifying microorganisms (i.e., microorganisms facilitating denitrification). Such microorganisms, in particular bacteria, may comprise one or more enzymes selected from the group consisting of NaR (nitrate reductase), Nir (nitrite reductase), NOR (nitric oxide reductase), and N₂OR (nitrous oxide reductase). Such sludge containing microorganisms, in particular bacteria, may be also added to the medium of interest (e.g., the wastewater) as demonstrated in the example below.

### DETAILS OF THE INVENTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

Wastewater to be treated in the present invention could be any of industrial wastewater or nitrification pre-treated wastewater comprising nitrate or nitrite to turn into nitrogen gases. For example, the wastewater is produced by adipic acid production process from cyclohexane. Preferably, the total nitrogen provided by the wastewater in the present invention is obtained by the total weight of NO₃⁻ The method for replacing the carbon source can be performed at a temperature between 15° C. and 30° C., preferably between 20° C. and 25° C.

Method to produce adipic acid could comprise the following steps: oxidation of liquid cyclohexane by reaction with oxygen gas at high temperature, to produce cyclohexane hydroperoxide; decomposition of the hydroperoxide into cyclohexanol and cyclohexanone, in the presence of a catalyst; oxidation of the cyclohexanol/cyclohexanone mixture to adipic acid, with nitric acid; extraction and purification of the adipic acid.

Several different processes have been used for the oxidation of cyclohexane into a product mixture containing cyclohexanone and cyclohexanol. Such product mixture is commonly referred to as a KA oil (ketone/alcohol oil) mixture. The KA oil mixture can be readily oxidized to produce adipic acid, which is an important reactant in processes for preparing certain condensation polymers, notably polyamides. Classical process to produce a mixture containing cyclohexanone and cyclohexanol is conducted in two steps to get KA oil through oxidation of cyclohexane. First, the thermal auto-oxidation of cyclohexane leads to the formation of cyclohexyl hydroperoxide (CyOOH) that is isolated. The second step, KA oil is obtained through the decomposition of CyOOH which is catalyzed by using chromium ions or cobalt ions as homogenous catalysts.

A wide range of carbon sources can be used to meet the soluble chemical oxygen demand (COD) needed for denitrification. The original carbon sources (the first carbon source) refer to organic carbon matters obtained within the inlet wastewater (as an organic wastewater load entering into the plant from the inlet) or from accumulated materials stored within the cells. Commonly used the original carbon source (a first carbon source) and displacement carbon sources (a second carbon sources) include, but not limited to, a mixture of butanedioic acid, glutaric acid and adipic acid, acetic acid, crude syrup, hydrolyzed starch, methanol, ethanol, acetate, glycerin, ethylene glycol, glucose, sodium acetate, molasses sugar. In the present invention, the first carbon source is preferably different from the second carbon source. The first carbon source is preferably ethylene glycol or a mixture of butanedioic acid, glutaric acid and adipic acid. The second carbon source is preferably glycerin or glucose.

The choice of carbon source typically will depend on the evaluation of a number of product attributes, including: safety, cost, handling requirements, ease of use, materials compatibility and so on. The choice of a carbon source can have profound implications not just on the efficacy of nutrient removal, but also on plant and personnel safety, sludge yields, aeration adequacy, environmental sustainability, overall effluent quality and other factors.

Carbon sources are generally pure products (e.g., methanol, ethanol), unrefined wastes, or purified waste materials derived from a variety of industrial and agricultural processes. Some typical sources of displacement carbon include spent sugars from food and beverage manufacturing and glycerol from bio-diesel production.

Denitrification generally uses organic matter (carbon source) as electron donor, and nitrate or nitrite as electron acceptor to be reduced to other gaseous oxides of nitrogen or nitrogen under anaerobic or anoxic conditions. In the present invention, chemical oxygen demand (COD) analysis method is conducted with “Water quality-Determination of the chemical oxygen demand-Dichromate method” (national standards of People's Republic of China, GB11914-89). The total nitrogen (TN) analysis method is conducted with “water quality—Determination of total nitrogen—Alkaine potassium persulfate digestion—UV spectro photometric method” (national standards of People's Republic of China, GB11894-89).

Step (a) then concerns replacing (an amount of) the first carbon source with (an amount of) the second carbon source, wherein the second carbon source is increased by an amount percentage of 1-15%, based on the total chemical oxygen demand of the first carbon source and the second carbon source (and repeating such step at least until 50% of the first source is replaced). As mentioned above, the first carbon source can also be referred to organic carbon matters obtained within the inlet wastewater (as an organic wastewater load entering into the plant from the inlet) or from accumulated materials stored within the cells.

Step (b) then concerns treating the wastewater with the mixing carbon source obtained in step a) for 10-20 days.

Step (c) concerns repeating steps a) and b) until the first carbon source is completely replaced by the second carbon source.

In step (a), (an amount of) the first carbon source is replaced with (an amount of) the second carbon source is increased by an amount percentage of 1-15%, based on the total chemical oxygen demand of the first carbon source and the second carbon source, preferably 1-10% each time. In step (b), the wastewater is treated for 10-20 days, preferably 10-15 days, especially after each change before achieving 40-60 wt %, preferably 40-55 wt %, more preferably 40-50 wt %, most preferably 50 wt % of the first carbon source replaced, based on the total chemical oxygen demand of the first carbon source and the second carbon source.

Regarding the dosage of carbon sources, notably of the second carbon sources, there are risks associated with underdosage as well as with overdosage. The weight ratio of chemical oxygen demand (COD) and total nitrogen (TN) in the inlet wastewater (COD/TN) in step (b) is controlled from 3.0 to 5.0, preferably from 3.0 to 4.5, more preferably from 3.0 to 4.0, even more preferably from 3.0 to 3.5. The total nitrogen (TN) in the wastewater can be determined by analysis method of “water quality—Determination of total nitrogen—Alkaine potassium persulfate digestion—UV spectro photometric method” (GB11894-89). Referred to the weight ratio of chemical oxygen demand (COD) and total nitrogen (TN) in the inlet wastewater, the amount of chemical oxygen demand (COD) can be determined. Based on the conversion factor for COD and carbon, the weight amount of carbon sources can be determined accordingly.

Conversion factor for chemical oxygen demand (COD) and carbon source:

g COD/g carbon source=(number of carbon atoms*2+number of hydrogen atoms*0.5−number of oxygen atoms)*16/molecular weight of carbon source

The process of the present invention permits to treat wastewater with sustainable qualified treated wastewater outlet. In preferred embodiment, the outlet total nitrogen (TN) is less than 20 mg/L, which is much lower than the standard specification (45-70 mg/L, “Wastewater quality standards for discharge to municipal sewers”, GB/T 31962-2015).

### EXPERIMENTAL PART

### Example 1

Different switch percentages were compared during carbon source change from ethylene glycol (EG) to glucose. In test 1, at the beginning, glucose percentage was increased for 10% each time e.g., 10%, 20%, 30%, 40% and 50%, and was maintained for 10 days after each replacement. Then, glucose percentage was increase faster compared with the beginning, e.g., 70%, 90% and 100%, and also run stably for 10 days for each time increase. During test 1, denitrification performance was good and stable with outlet TN less than 20 mg/L. In test 2, the replacement speed was faster than test 1, glucose percentage was set as 20%, 40%, 60% 80%, 100% and each time was also maintained for 10 days, it was found that denitrification was not stable, outlet TN was many times more than 70 mg/L (specification: 45 mg/L). In the tests, the ratio of total chemical oxygen demand of the mixture of ethylene glycol (EG) and glucose to the total amount of nitrogen of the wastewater is 3.5.

TABLE 1
Comparison on the second carbon source percentage

| | | Time | | | | | | | | |
|---|---|---|---|---|---|---|---|---|---|---|
| | | 10 | 10 | 10 | 10 | 10 | 10 | 10 | 10 | 10 |
| | | days | days | days | days | days | days | days | days | days |
| Glucose | test 1 | 10 | 20 | 30 | 40 | 50 | 70 | 90 | 100 | 100 |
| percentage (%) | test 2 | 20 | 40 | 60 | 80 | 100 | 100 | 100 | 100 | 100 |
| inlet average TN | test 1 | 1000 | 1000 | 1000 | 1000 | 1000 | 1000 | 1000 | 1000 | 1000 |
| (mg/L) | test 2 | 1000 | 1000 | 1000 | 1000 | 1000 | 1000 | 1000 | 1000 | 1000 |
| outlet average TN | test 1 | 26 | 25 | 22 | 21 | 22 | 19 | 18 | 20 | 17 |
| (mg/L) | test 2 | 33 | 45 | 62 | 66 | 55 | 57 | 44 | 47 | 44 |
| Spec TN = 45 mg/L | | | | | | | | | | |

### Example 2

In order to investigate the impact of maintain time after each time substituted carbon percentage increase, test 3, 4 and 5 were implemented, with maintain time as 20 days, 5 days and 30 days respectively. In test 3, denitrification performance was good and stable, similar with test 1 (10 days). In test 4, many times outlet TN was higher than 50 mg/L due to too short time (5 days only) running after switch percentage increase. In test 4, no improvement was found on denitrification performance after extending to 30 days, and more time was consumed. Based on the comparison test, it was recommended to choose 10-20 days as maintain time. In the tests, the ratio of total chemical oxygen demand of the mixture of ethylene glycol (EG) and glucose to the total amount of nitrogen of the wastewater is 3.5.

TABLE 2
Comparison on maintain time for each replacement

| | | Glucose percentage (%) | | | | | | | | |
|---|---|---|---|---|---|---|---|---|---|---|
| | | 10 | 20 | 30 | 40 | 50 | 70 | 90 | 100 | 100 |
| Maintain time | test 1 | 10 | 10 | 10 | 10 | 10 | 10 | 10 | 10 | 10 |
| (days) | test 3 | 20 | 20 | 20 | 20 | 20 | 20 | 20 | 20 | 20 |
| | test 4 | 5 | 5 | 5 | 5 | 5 | 5 | 5 | 5 | 5 |
| | test 5 | 30 | 30 | 30 | 30 | 30 | 30 | 30 | 30 | 30 |
| outlet average TN | test 1 | 26 | 25 | 22 | 21 | 22 | 19 | 18 | 20 | 17 |
| (mg/L) | test 3 | 25 | 22 | 19 | 22 | 21 | 16 | 17 | 18 | 18 |
| | test 4 | 26 | 33 | 45 | 55 | 63 | 52 | 51 | 53 | 49 |
| | test 5 | 21 | 25 | 30 | 24 | 23 | 27 | 23 | 25 | 24 |

### Example 3

In order to investigate the impact of COD/TN ratio on denitrification performance during carbon source change from ethylene glycol (EG) to glucose, first batch test was conducted in beakers at the condition of 50% of first carbon source replaced. The same sludge were added into seven 1.0 L beakers, 1000 mg/L initial TN was prepared and carbon source was added with COD/TN weight ratio (g/g) at 2.0, 3.0, 3.5, 4.0, 4.5, 5.0. Every 4 hours, samples were taken from beaker, and COD and TN were analyzed.

TN Removal

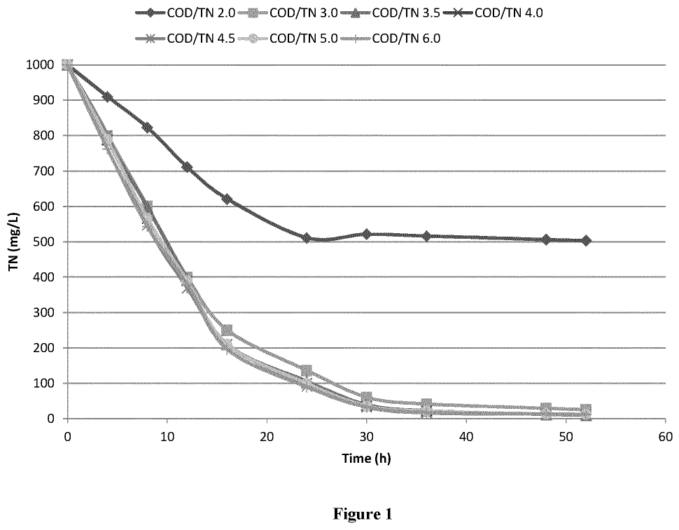

COD/TN=2.0, TN removal is not completed with outlet TN ˜500 mg/L, when COD/TN ratio 3.0, 3.5, 4.0, 4.5, 5.0 and 6.0, final TN was ˜20 mg/L, seen as FIG. 1.

Residue Carbon (COD)

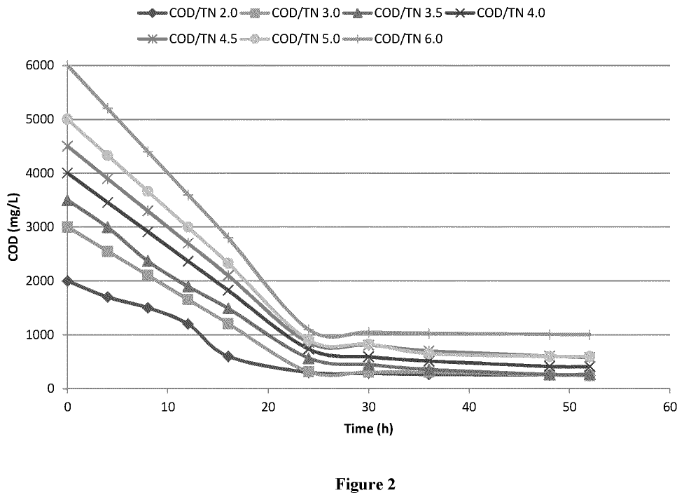

With COD/TN increase, residue COD will increase. At COD/TN=6.0, residue COD in the outlet wastewater is more than 1000 mg/L. When COD/TN=2.0, 3.0, 3.5, 4.0, 4.5, 5.0, 6.0, final COD were 246, 245, 266, 409, 579, 599, respectively, seen as FIG. 2.

Based on TN removal and residue COD, COD/TN ratio need be kept at 3.0˜5.0.

Long Term Study

In order to further study the impact of COD/TN on denitrification, 4000 mg/L initial TN is prepared for a long term study launched by pilot test, which is only based on single carbon source (glucose).

From the above graph, COD/TN 3.0-5.0 was comfortable for denitrification, and when COD/TN=2.0 or 6.0, outlet TN will increase. Since outlet TN was higher than 30 mg/L at COD/TN ratio of 6.0, after COD/TN ratio decreased back to 5.0 and 4.5, denitrification performance was improved with outlet TN<30 mg/L that is less than the specification (specification: 45 mg/L).

The disclosure will now be illustrated with working examples, which is intended to illustrate the working of disclosure and not intended to take restrictively to imply any limitations on the scope of the present disclosure. Other examples are also possible which are within the scope of the present disclosure.

1.-13. (canceled)

14. A method for replacing a carbon source in a wastewater denitrifying process, wherein the process comprises a step of treating wastewater with a first carbon source, the method for replacing the carbon source comprises the steps of:
a) replacing the first carbon source with a second carbon source which is different from the first carbon source, wherein the second carbon source is increased by an amount percentage of 1-15% by weight, based on the total chemical oxygen demand of the first carbon source and the second carbon source;
b) treating the wastewater with the mixture of the first carbon source and the second carbon source obtained in step a) for 10-20 days; and
c) repeating steps a) and b) until at least until 50% of the first source is replaced; wherein the first carbon source is further replaced with the second carbon source after step c) is completed until the first carbon source is completely replaced by the second carbon source,
wherein the ratio of total chemical oxygen demand of the mixture of the first carbon source and the second carbon source to total nitrogen of inlet wastewater in step b) is from 3.0 to 5.0.

15. The method according to claim 14, wherein the method for replacing the first carbon source with the second carbon source is performed at a temperature between 15° C. and 30° C.

16. The method according to claim 14, wherein the second carbon source is increased by a weight percentage of 1-10%, based on the total chemical oxygen demand of the first carbon source and the second carbon source in step a).

17. The method according to claim 14, wherein the ratio of total chemical oxygen demand of the mixture of first carbon source and the second carbon source to the total nitrogen of the wastewater in step b) is from 3.0 to 4.5.

18. The method according to claim 14, wherein the wastewater comprises nitrate.

19. The method according to claim 14, wherein the total nitrogen content of the wastewater is based on the total weight of nitrate.

20. The method according to claim 14, wherein the wastewater is produced from an adipic acid production process from cyclohexane.

21. The method according to claim 14, wherein the first carbon source or the second carbon source can be independently selected from the group consisting of: a mixture of butanedioic acid, glutaric acid, and adipic acid, acetic acid, crude syrup, hydrolyzed starch, methanol, ethanol, acetate, glycerin, ethylene glycol, glucose, sodium acetate, and molasses sugar.

22. The method according to claim 14, wherein the second carbon source is increased by a weight percentage of 1-10%, based on the total chemical oxygen demand of the first carbon source and the second carbon source each time in step a).

23. The method according to claim 14, wherein the first carbon source is ethylene glycol or a mixture of butanedioic acid, glutaric acid, and adipic acid.

24. The method according to claim 14, wherein the second carbon source is glycerin or glucose.

25. The method according to claim 14, wherein the first carbon source is ethylene glycol and the second carbon source is glucose.

26. The method according to claim 14, wherein the first carbon source is replaced with the second carbon source having an amount percentage of 10-20% by weight, based on the total chemical oxygen demand of the first carbon source and the second carbon source, after 50% of the first carbon source is replaced by the second carbon source.
